(19) United States
(12) Patent Application Publication
(10) Pub. No.: US 2007/0072100 A1
(43) Pub. Date: Mar. 29, 2007

(54) Manufacturing method of color cathode ray tube and exposure device used for the manufacturing method

(75) Inventors: Yoichi Ito, Mobara (JP); Satoshi Muto, Mobara (JP); Ryuichi Nishimori, Mobara (JP)

Correspondence Address: MILBANK, TWEED, HADLEY & MCCLOY, 1 CHASE MANHATTAN PLAZA, NEW YORK, NY, 10005-1413, US

(73) Assignee: Hitachi Displays, Ltd.

(21) Appl. No.: 11/525,625

(22) Filed: Sep. 22, 2006

(30) Foreign Application Priority Data
Sep. 28, 2005 (JP) 2005-282121

(51) Int. Cl. H01J 9/227

(52) U.S. Cl. 430/24; 430/25; 355/67

(57) ABSTRACT

In a manufacturing method of a color cathode ray tube, as an exposure light source which is used in the exposure for forming a phosphor screen, an ultra-high pressure mercury lamp having an arc length of 35 to 60 mm is used. According to the present invention, it is possible to make an aperture shape of a black matrix film of a color cathode ray tube uniform and it is also possible to enhance the operational efficiency.

### BACKGROUND OF THE INVENTION

1. Field of the Invention

The present invention relates to the manufacture of a color cathode ray tube, and more particularly to the phosphor screen forming exposure.

2. Description of the Related Art

A color cathode ray tube, for example, a color cathode ray tube which is used in a color television set, a color display monitor for an OA equipment terminal includes a vacuum envelope. The vacuum envelope is constituted of an approximately rectangular panel portion which has a phosphor screen including a black matrix (BM) film or a large number of dot-like or stripe-like phosphor layers on an inner surface thereof, an approximately cylindrical-shape neck portion which houses an electron gun therein, and an approximately funnel-like funnel portion which connects the neck portion and the above-mentioned panel portion on an axis which is substantially coaxial with a tube axis and includes a deflection yoke on an outer periphery of a transitional region between the neck portion and the panel portion. Further, in the inside of the vacuum envelope, a shadow mask which constitutes a color selection electrode and includes a large number of electron beam apertures is arranged in the vicinity of the phosphor screen in an opposed manner.

The above-mentioned shadow mask uses an aluminum killed steel as a main constituting material thereof. Further, with respect to the shadow mask, along with a recent demand for high definition of the color cathode ray tube, a shadow mask has been made of thin plate. In a color cathode ray tube which adopts the thin shadow mask, a phenomenon in which a portion of the shadow mask is deformed by heat so that an electron beam spot is displaced from a given position on a phosphor screen during a displaying operation, that is, a so-called mask doming phenomenon is liable to easily occur.

As a means to cope with such a phenomenon, along with the improvement of a shadow mask suspension mechanism, an Invar material is also used as the constitutional material in view of the thermal expansion coefficient and the physical hardness.

Such a shadow mask is formed as follows. A form in which a large number of electron beam apertures are formed at given positions by etching is blanked in a given shape. Thereafter, the blanked form is formed into a shape using a press such that the shadow mask is constituted of an approximately spherical main surface and a skirt portion which is contiguously formed with a periphery of the main surface and is bent by approximately 90 degrees with respect to the main surface and the shadow mask is used.

Further, recently, along with the popularization of a color television set or a color display monitor having a flat screen type, there is observed a tendency that an outer surface of a face plate (panel glass) is leveled or flattened with respect to the color cathode ray tube which is used in the color television set and the color display monitor.

FIG. 13 is a schematic cross-sectional view for explaining a constitutional example of a shadow-mask-type color cathode ray tube of a flat panel type.

In FIG. 13, a vacuum envelope is constituted of a panel portion 51 which forms a phosphor screen 50 having a black matrix film which consists of phosphor pixels and a non-light-emitting light absorbing material layer on an inner surface thereof, a neck portion 52 which houses an electron gun 61, and a funnel portion 53 which connects the panel portion 51 and the neck portion 52.

The panel portion 51 includes an approximately flat outer surface and a concavely curved inner surface. The phosphor screen 50 which is arranged on the inner surface of the panel portion 51 includes, in general, phosphor pixels which are formed by applying phosphor layers of three colors consisting of red (R), green (G), blue (B) respectively in a dotted pattern or in a stripe pattern thereto, a black matrix film which surrounds the phosphor pixels and is formed of a non-light-emitting light absorbing material layer made of carbon, and a metal reflection film which constitutes a metal back layer.

Further, a shadow mask 54 is arranged close to the phosphor screen 50. The shadow mask 54 is formed of Invar material by taking a thermal expansion coefficient and a physical hardness into consideration.

The shadow mask 54 is of a self-standing shape-holding type which is formed by a press, wherein a periphery of the shadow mask 54 is welded to a mask frame 57, and the shadow mask 54 is suspended and supported on stud pins 60 which are mounted upright on an inner wall of a skirt portion of the panel portion 51 by way of suspension springs 59. Here, a magnetic shield 58 is fixed to an electron-gun-61-side of the mask frame 57. A deflection yoke 55 is exteriorly mounted on a transitional region between the neck portion 52 and the funnel portion 53 of the vacuum envelope, wherein by deflecting three modified electron beams B which are irradiated from the electron gun 61 in the horizontal direction (X direction) and the vertical direction (Y direction), the electron beams B are scanned two-dimensionally on the phosphor screen 50 thus reproducing the image.

Further, an inner conductive film 62 which is formed on an inner surface of the funnel portion 53 applies a high voltage introduced from an anode button to electrodes which form a main lens of an electron gun 61 and a metal reflection film of the phosphor screen 50. Numeral 63 indicates a reinforcing band, numeral 64 indicates a mouthpiece, and numeral 65 indicates a whole color cathode ray tube.

In the color cathode ray tube having such a constitution, as described previously, the panel portion 51 has the approximately flat outer surface and the concavely curved inner surface. To the contrary, the shadow mask 54 is shaped into the given curved surface by molding the shadow mask form using a press and is curved in conformity with the inner surface of the panel portion 51.

The reason the inner surface of the panel portion 51 and the shadow mask 54 are curved irrespective of the approximately flat external surface of the panel portion 51 is that the manufacturing method of the shadow mask 54 by a press forming technique can be performed easily and at a low cost.

The curved shape of the shadow mask 54 is an aspherical shape in which radii of curvature are gradually decreased from the center of a main surface to a periphery of the shadow mask 54 respectively along a long axis, a short axis and a diagonal line of the shadow mask 54 respectively.

The curvatures of the shadow mask 54 of the aspherical shape are determined as follows, for example, wherein an equivalent radius of curvature is set as Re.
Re=(z2+e2)/2z

Here, e: a distance (mm) in the direction orthogonal to a tube axis from the center to an arbitrary peripheral position on a main surface of the shadow mask.

z: a falling quantity (mm) in the tube axis direction from the center of the main surface of the shadow mask at the above-mentioned arbitrary peripheral position.

Such a specification establishes the compatibility between a flat feeling of the screen and the maintenance of a mechanical strength of the shaped shadow mask in the color cathode ray tube.

FIG. 14 is a schematic cross-sectional view showing a portion of an essential part of the color cathode ray tube shown in FIG. 13 in an enlarged manner. In FIG. 14, the phosphor screen 50 formed on the inner surface of the panel portion 51 includes three-color phosphor pixels 501 which are formed by applying phosphors of three colors in a dotted pattern or a stripe pattern, a black matrix film 502 which surrounds the phosphor pixels 501, and a metal reflection film 503, wherein the shadow mask 54 is arranged close to the phosphor screen 50 in a state that the shadow mask 54 faces the phosphor screen 50 in an opposed manner.

The three-color phosphor pixel 501 is constituted of a red (R) phosphor pixel 501R, a green (G) phosphor pixel 501G and a blue (B) phosphor pixel 501B. The three-color phosphor pixels 501 are respectively formed on opening portions (window portions) formed in the black matrix film 502 through exposure steps in which phosphor slurries of the respective colors are applied to an inner surface of the panel portion on which the black matrix film 502 is formed and, thereafter, the exposure indicated by arrows is performed via corresponding particular electron beam apertures 541 formed in the shadow mask 54 respectively from positions of three light sources 66G, 66B, 66R indicated by imaginary lines.

In forming the black matrix film 502, a photoresist in a slurry form is applied to the inner surface of the panel portion and, thereafter, the photoresist is exposed, and the photoresist is removed except for photosensitive portions. Then, graphite is applied to the inner surface of the panel portion and the photosensitive portions of the photoresist are removed thus forming opening portions for forming phosphor layers in the black matrix film. In the exposure step for forming the black matrix film, the exposure is performed three times by changing the positions of the light source for forming the opening portions for green phosphors, the opening portions for blue phosphors and the opening portions for red phosphors.

One example of an exposure device which is used in such exposure is shown in FIG. 15. In FIG. 15, numeral 67 indicates a light source lamp, numeral 68 indicates a lamp housing, numeral 69 indicates a correction lens, numeral 70 indicates a correction filter, and numeral 71 indicates a casing.

In the exposure device, a body to be exposed in which the shadow mask 54 is mounted in the inside of the panel 51 which includes a phosphor screen forming member on an inner surface thereof is placed on an upper surface of the casing 71.

In such a state, the light source lamp 67 which is arranged in the inside of the lamp housing 68 is allowed to emit light, the above-mentioned phosphor screen forming member is exposed using beams which passes through the correction lens 69, the correction filter 70 and the shadow mask 54.

In this exposure device, as the light source lamp 67, there has been proposed a straight-pipe long-arc type ultra-high pressure mercury lamp which is disclosed in patent document 1 (see JP-A-2001-312964) and a short-arc type mercury lamp which is disclosed in patent document 2 (see JP-A-10-112289).

### SUMMARY OF THE INVENTION

In the flat-panel-type color cathode ray tube having an approximately flat outer surface, a wall thickness of the panel portion differs between a center portion and a peripheral portion. Due to the difference in the wall thickness of the panel portion, the generation of the distortion of the screen is observed. The distortion of the screen becomes one of factors which cause the generation of mislanding and gives rise to a drawback that it is difficult to manufacture a color cathode ray tube which exhibits the excellent color purity. Accordingly, there has been a demand for a solution which can overcome the drawback.

Further, in forming the phosphor screen, it is inevitably necessary to perform exposure steps plural times to form a black matrix film and phosphor pixels and time necessary for performing this exposure considerably impedes the operational efficiency. Accordingly, a solution of this drawback has been urgently demanded.

To overcome the above-mentioned drawbacks, according to the present invention, an exposure light source used at the time of performing exposure for forming a phosphor screen is formed of an ultra high pressure mercury lamp having an arc length of 35 mm to 60 mm.

According to the present invention, by setting the arc length of the exposure light source to a value which falls within a range from 35 mm to 60 mm, it is possible to enhance the uniformity of the aperture size of the black matrix film thus enabling the manufacture of the color cathode ray tube which exhibits the excellent color purity. Further, it is possible to realize the shortening of an exposure time thus enabling the enhancement of the operational efficiency.

According to the present invention, by relatively displacing the light source and an exposed screen from each other, it is possible to enhance the uniformity of the aperture size of the black matrix film thus enabling the manufacture of the color cathode ray tube which exhibits the excellent color purity.

According to the present invention, by setting an output frequency of the power source unit to a value which falls within a range from 10 kHz to 30 kHz, it is possible to suppress the change of a light output of the exposure light source. Accordingly, it is possible to enhance the uniformity of the aperture size of the black matrix film thus enabling the manufacture of the color cathode ray tube which exhibits the excellent color purity.

According to the present invention, by setting the arc length of the exposure light source to a value which falls within a range from 35 mm to 60 mm, it is possible to suppress the change of the size of the phosphor pixel thus enabling the manufacture of the color cathode ray tube which exhibits the excellent color purity. Further, it is also possible to realize the shortening of an exposure time thus enabling the enhancement of the operational efficiency.

According to the present invention, by relatively displacing the light source and the exposed screen, it is possible to suppress the fluctuation of the size of the phosphor pixels thus enabling the manufacture of the color cathode ray tube which exhibits the excellent color purity.

According to the present invention, by setting an input frequency to the light source to a value which falls within a range from 10 kHz to 30 kHz and hence, it is possible to suppress the fluctuation of a light output of the exposure light source. Accordingly, it is possible to enhance the uniformity of the phosphor pixels thus enabling the manufacture of the color cathode ray tube which exhibits the excellent color purity.

According to the present invention, with the use of the exposure device which includes the exposure light source having the arc length of 35 mm to 60 mm, the aperture size of the black matrix film and the phosphor pixel are made uniform thus realizing the manufacture of the color cathode ray tube which exhibits the excellent color purity. Further, it is possible to shorten the exposure time thus enhancing the operational efficiency.

According to the present invention, by setting a length of a slit shorter than the arc length of the light source, the aperture size of the black matrix film and the phosphor pixel are made uniform thus realizing the manufacture of the color cathode ray tube which exhibits the excellent color purity.

According to the present invention, with the use of the exposure device which sets an output frequency of a power source unit to a value which falls within a range from 10 kHz to 30 kHz, the fluctuation of light output can be suppressed, and the aperture size of the black matrix film and the phosphor pixel are made uniform thus realizing the manufacture of the color cathode ray tube which exhibits the excellent color purity.

According to the present invention, by adopting the mechanism which displaces the light source in the same plane, the fluctuation of light output can be suppressed, and the aperture size of the black matrix film and the phosphor pixel are made uniform thus realizing the manufacture of the color cathode ray tube which exhibits the excellent color purity.

### BRIEF DESCRIPTION OF THE DRAWINGS

FIG. 1 is a schematic plan view showing an example of an exposure device for explaining a method for manufacturing a color cathode ray tube according to the present invention;

FIG. 2 is a schematic cross-sectional view taken along a line A-A in FIG. 1;

FIG. 3 is a schematic cross-sectional view showing an example of the combined constitution of correction lenses and correction filters of the present invention;

FIG. 4A, FIG. 4B and FIG. 4C are views showing examples of monochroic local correction filters of the present invention, wherein FIG. 4A and FIG. 4C are schematic plan views of the local correction filters for sidebeams and FIG. 4B is a schematic plan view of the local correction filter for center beams;

FIG. 5 is a schematic plan view showing an example of a common local correction filter of the present invention;

FIG. 6 is a schematic plan view showing an example of a grading filter of the present invention;

FIG. 7 is a schematic plan view showing an example of an exposure light source device used in the manufacturing method of a color cathode ray tube of the present invention;

FIG. 8 is a schematic cross-sectional view taken along a line B-B in FIG. 7;

FIG. 9 is a schematic plan view showing an example of a mercury lamp assembling of the exposure light source device used in the manufacturing method of the color cathode ray tube of the present invention;

FIG. 10 is a constitutional view showing an example of a power source unit of the exposure light source device used in the manufacturing method of the color cathode ray tube of the present invention;

FIG. 11 is a view showing the relationship between a light profile and an illuminance of the exposure light source which are used in the manufacturing method of the color cathode ray tube of the present invention;

FIG. 12 is a schematic cross-sectional view showing another example of an exposure device for explaining the method for manufacturing a color cathode ray tube of the present invention;

FIG. 13 is a schematic constitutional view for explaining the structure of a flat-face-type shadow-mask color cathode ray tube;

FIG. 14 is an enlarged cross-sectional view of an essential part in FIG. 13; and

FIG. 15 is a schematic cross-sectional view showing an example of a conventional exposure device.

### DESCRIPTION OF THE PREFERRED EMBODIMENTS

Hereinafter, preferred embodiments of the present invention are explained in detail in conjunction with drawings which show the embodiments.

### Embodiment 1

A color cathode ray tube is constituted of a panel portion which includes a phosphor screen on which a black matrix film having a plurality of opening portions and three kinds of phosphor pixels which are arranged in the opening portions of the black matrix film are formed on an inner surface thereof, and a shadow mask which is arranged to face the phosphor screen formed on the inner surface of the panel portion in an opposed manner and includes a large number of electron beam apertures.

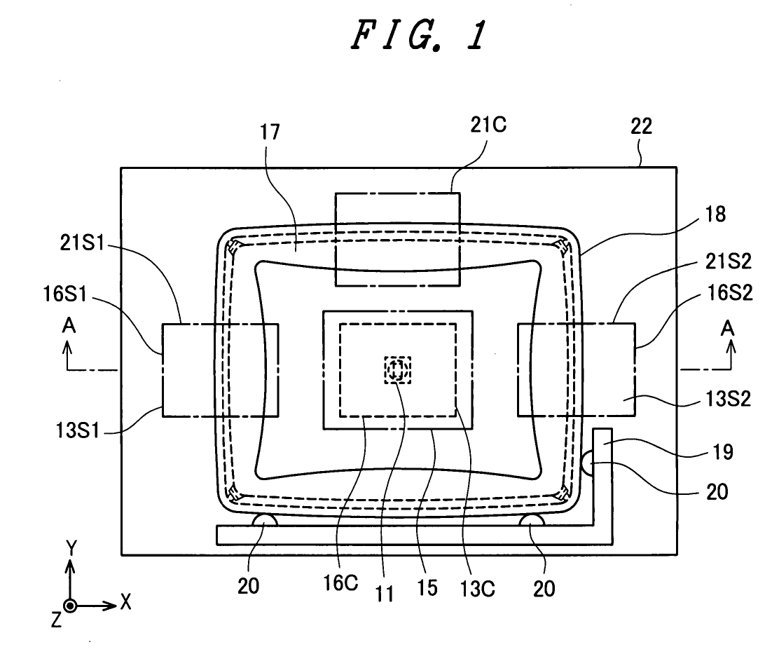

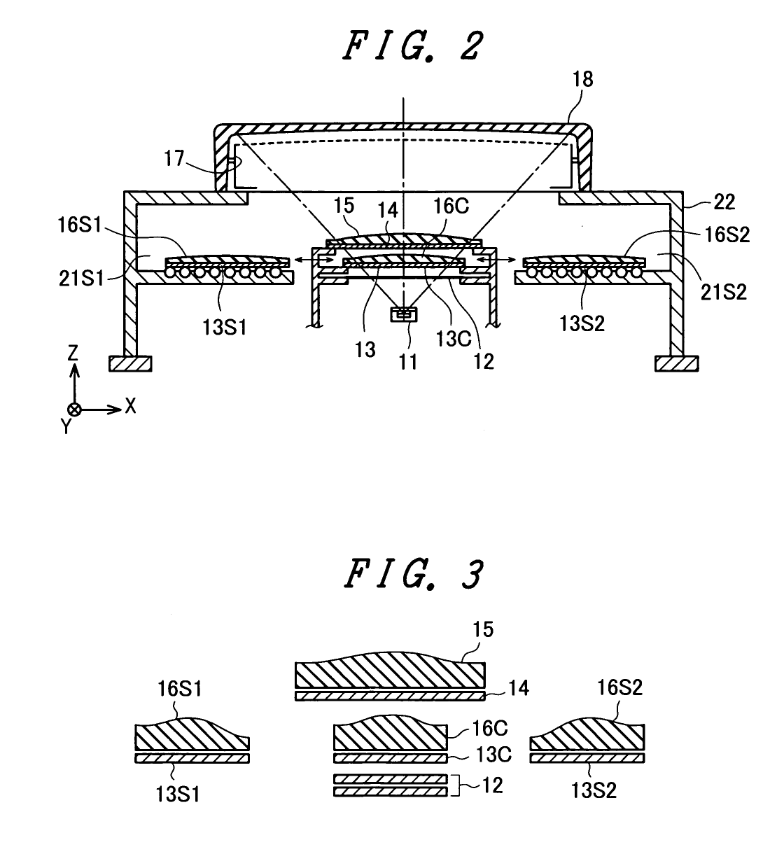

FIG. 1 and FIG. 2 are views for explaining a manufacturing method of a color cathode ray tube of the present invention, wherein FIG. 1 is a schematic plan view showing an example of an exposure device and FIG. 2 is a cross-sectional view taken along a line a line A-A in FIG. 1. In FIG. 1 and FIG. 2, numeral 11 indicates an exposure light source device, and the detailed explanation is described later. Further, numeral 12 indicates a grading filter, numeral 13 (13c, 13s1, 13s2) indicates monochroic local correction filters, numeral 14 indicates a multi-color local correction filter, numeral 15 indicates a common correction lens, numeral 16 (16c, 16s1, 16s2) indicates a plurality of monochroic correction lenses, numeral 17 indicates a shadow mask, numeral 18 indicates a panel portion, numeral 19 indicates a panel positioning jig, numeral 20 indicates projections, numeral 21 (21s1, 21s2) indicates a storing chamber, and numeral 22 indicates a device body.

By using such an exposure device, a phosphor screen having a given pattern is formed.

The flat-face-type panel portion 18 which has an approximately flat outer surface and allows the peripheral portion thereof to have a larger wall thickness compared to the center portion thereof is, in a state that the shadow mask 17 is mounted on the inner side of the panel portion 18, mounted on the device body 22 by being brought into contact with projections 20 of the panel positioning jig 19. Then, the panel portion 18 is exposed by the beams from an exposure light source device 11.

Particularly, the step for forming the black matrix film comprises an exposure step of opening portions (hereinafter, referred to as a hole) for a first phosphor pixel, an exposure step of second phosphor pixel holes, and an exposure step of third phosphor pixel holes.

In the exposure step of the first phosphor pixel holes, the exposure is performed by arranging a common correction lens 15 and the first monochroic correction lens 16C between the inner surface of the panel and the exposure light source.

In the exposure step of the second phosphor pixel holes, the exposure is performed by arranging the common correction lens 15 and the second monochroic correction lens 16S1 between the inner surface of the panel and the exposure light source.

In the exposure step of the third phosphor pixel holes, the exposure is performed by arranging the common correction lens 15 and the third monochroic correction lens 16S2 between the inner surface of the panel and the exposure light source.

The common correction lens 15 is used in common in the exposure steps of the first phosphor pixel holes, the second phosphor pixel holes and the third phosphor pixel holes.

A profile of a lens forming portion which constitutes an effective region of the common correction lens 15 has a rectangular shape. The common correction lens 15 is formed in a left-and-right symmetry with respect to a longitudinal axis (Y axis) of the common correction lens 15, and is formed in an up-and-down symmetry with respect to a lateral axis (X axis) of the common correction lens 15.

Further, the exposure for forming the green phosphor pixels is performed in the exposure step of the first phosphor pixel holes, the exposure for forming the blue phosphor pixels is performed in the exposure step of the second phosphor pixel holes, and the exposure for forming the red phosphor pixels is performed in the exposure step of the third phosphor pixel holes.

According to the present invention, in performing the exposure, the exposure is performed by interposing, in combination, a plurality of correction filters consisting of the common correction lens 15 which is used in common in exposures performed three times as the correction lens, the monochroic correction lenses 16 (16C, 16S1, 16S2) which are used for respective exposures performed three times, the grading filter 12 which is used in common in exposures performed three times in which the optical transmissivity is changed between the center and the periphery as the correction filter, the monochroic local correction filter 13 which is used for every exposure with the correction of fixed transmissivity, and the common local correction filter 14 which is used in common in exposures performed three times with the fixed transmissivity correction thus forming a given pattern.

The monochroic correction lenses 16 for respective colors are constituted of a center-beam correction lens 16C and both side-beam correction lenses 16S1, 16S2 and these correction lenses are respectively used in combination with the position of the exposure light source 11. That is, in the center-beam exposure, the center-beam correction lens 16C which is retracted in a storing chamber 21C in the Y-axis direction is moved to a given position in the vicinity of a tube axis from the retracting position.

After the movement, the exposure is made by combining the center-beam correction lens 16C with the common correction lens 15, the grading filter 12, the common local correction filter 14 and the monochroic local correction filter 13C which are preliminarily arranged in place in the vicinity of tube axis. After the completion of the exposure, the center-beam correction lens 16C is retracted and stored in the storing chamber 21C and stands by in the storing chamber 21C.

On the other hand, both side-beam correction lenses 16S1, 16S2 are also respectively moved to the given positions in the vicinity of the tube axis from the respective storing chambers 21S1, 21S2 at the time of performing the side-beam exposure. After the movement, the exposure is made by combining both side-beam correction lenses 16S1, 16S2 with the common correction lens 15, the grading filter 12, the common local correction filter 14 and the monochroic local correction filters 13S1, 13S2 which are preliminarily arranged at the given position in the vicinity of the tube axis. After the completion of the exposure, both side-beam correction lenses 16S1, 16S2 are respectively retracted and stored in the storing chambers 21S1, 21S2 and stand by in the storing chambers 21S1, 21S2. In performing the respective exposures, the position of the light source is changed in the same manner as the related art. Further, it is possible to allow the exposure light source to be tilted in the same plane at the time of exposing.

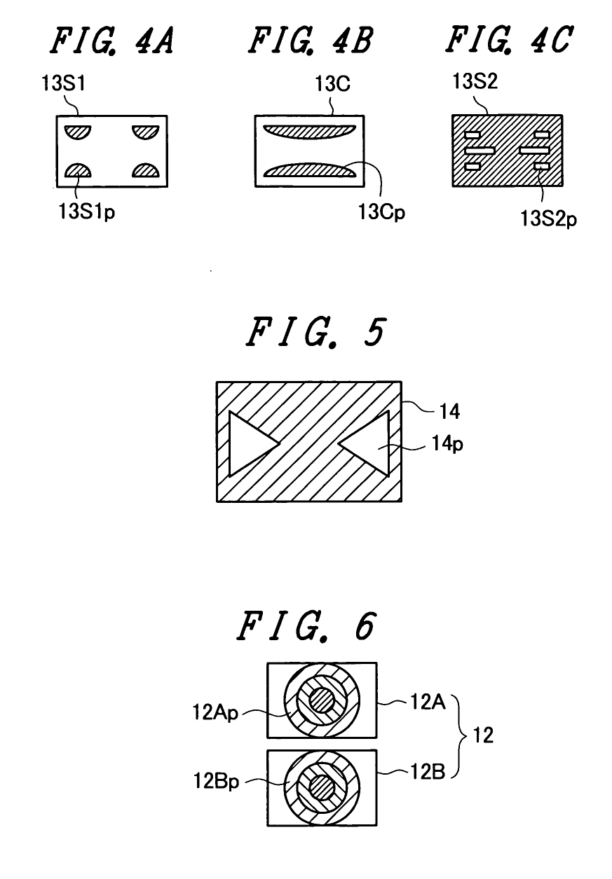

FIG. 3 to FIG. 6 show examples of the correction lens and the correction filter which are used in the method for manufacturing the color cathode ray tube of the present invention, wherein FIG. 3 is a schematic cross-sectional view showing one example of the combined constitution of the correction lenses and the correction filters. FIG. 4A, FIG. 4B and FIG. 4C are views showing monochroic local correction filters, wherein FIG. 4A and FIG. 4C are schematic plan views of the local correction filters for side beams and FIG. 4B is a schematic plan view of the local correction filter for center beams. FIG. 5 is a schematic plan view showing the common local correction filter. FIG. 6 is a schematic plan view of the grading filter. In these respective drawings, parts identical with the parts shown in the above-mentioned drawings are given the same symbols.

In FIG. 3, the grading filter 12, the common local correction filter 14 and the common correction lens 15 are coaxially arranged, and depending on the respective exposures for center beams and side beams, any one of the monochroic local correction filters 13 and any one of the monochroic correction lenses 16 which forms a pair with a monochroic local correction filter 13 are selected.

FIG. 4A to FIG. 4C indicate examples of the correction patterns of the local correction filters 13, wherein the side-beam local correction filter 13S1 shown in FIG. 4A adopts a half-moon-shaped pattern 13S1p and another side-beam local correction filter 13S2 shown in FIG. 4C adopts a rectangular pattern 13S2p. Further, the center beam local correction filter 13C shown in FIG. 4B adopts an arcuate pattern 13Cp.

FIG. 5 shows an example of a correction pattern of the common local correction filter 14, wherein the common local correction filter 14 adopts a triangular pattern 14p having high transmissivity at both ends thereof in the X direction.

FIG. 6 shows examples of the correction patterns of the grading filter 12. The grading filter 12 is constituted of two grading filters 12A, 12B having approximately concentric patterns 12Ap, 12Bp which exhibit the lowest optical transmissivity at a center portion thereof and gradually increases the optical transmissivity in the direction toward a peripheral portion thereof.

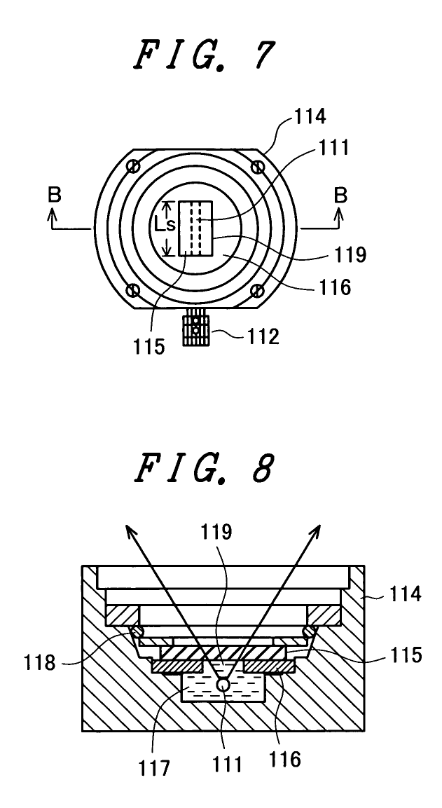

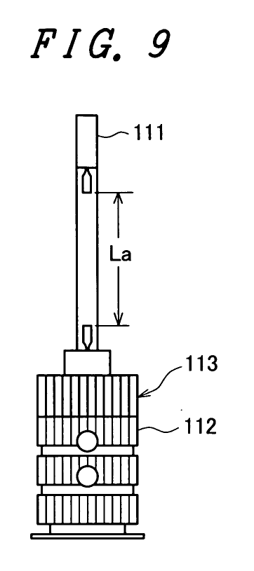

FIG. 7 to FIG. 9 are schematic views showing one example of the exposure light source device 11, wherein FIG. 7 is a plan view, FIG. 8 is a cross-sectional view taken along a line B-B in FIG. 7, and FIG. 9 is a plan view of a mercury lamp assembly.

In FIG. 7 to FIG. 9, numeral 111 indicates an exposure light source, numeral 112 indicates a lamp holder, numeral 113 indicates the mercury lamp assembly, numeral 114 indicates a lamp casing, numeral 115 indicates a cover glass, numeral 116 indicates an aperture plate, numeral 117 indicates cooling water, numeral 118 indicates an O ring, and numeral 119 indicates a slit.

The exposure light source 111 is constituted of a long-arc type ultra-high pressure mercury lamp of a straight-pipe type, which has an arc length La of 35 to 60 mm. It is preferable to set the arc length La to approximately 50 mm from a viewpoint of enhancement of the operational efficiency and the dimensional accuracy of the portion to be exposed.

The mercury lamp assembly 113 is formed such that the lamp holder 112 is mounted on one end of the exposure light source 111. The mercury lamp assembly 113 is arranged on a bottom side of the lamp case body 114, the aperture plate 116 having the slit 119 and the cover glass 115 are assembled over the mercury lamp assembly 113, and the exposure light source 111 is cooled by the cooling water 117.

The exposure light source 111 is assembled in the inside of the lamp case body 114 in a state that the center in the lengthwise direction (in the lengthwise direction parallel to a tube axis) of the exposure light source 111 is approximately aligned with the center of a length Ls of the slit 119 which is formed in the aperture plate 116 in the direction parallel to the tube axis of the exposure light source 111 and.

A relationship between the length Ls of the slit 119 and the arc length La is set to Ls<La, and, it is particularly preferable to set the relationship to (0.4 to 0.8) Ls=La. When the Ls/La relationship is less than 0.4, it is wasteful from a viewpoint of light emitting efficiency, while, when the Ls/La relationship exceeds 0.8, a flared-shape of the light profile at the time of performing the exposure is disturbed and hence, the size of the exposed portion may be changed. Accordingly, it is preferable to set the Ls/La relationship to a value which falls within the above-mentioned range. Further, the constitution in which the exposure light source 111 is cooled in the inside of the lamp case body 114 using the cooling water 119 is equal to the conventional constitution.

Still further, by allowing the exposure light source device 11 to be swung in the same plane, it is possible to enhance the uniformity of a shape of the opening portion formed in the black matrix film and a shape of the phosphor pixel.

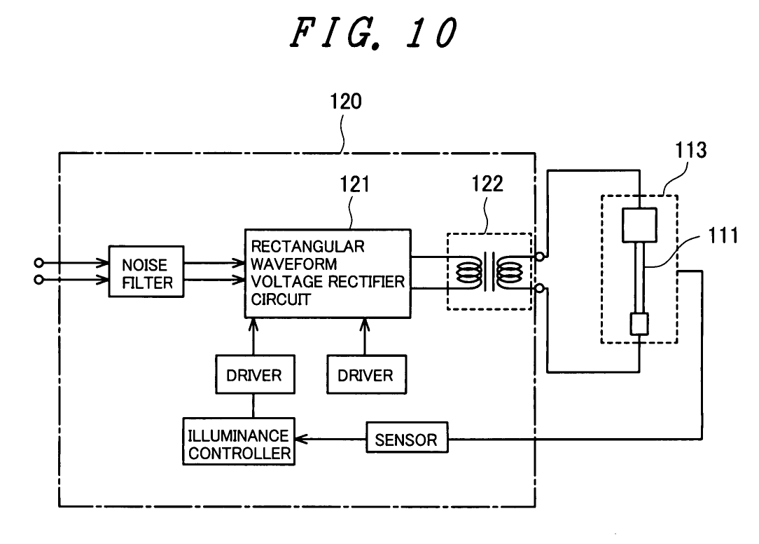

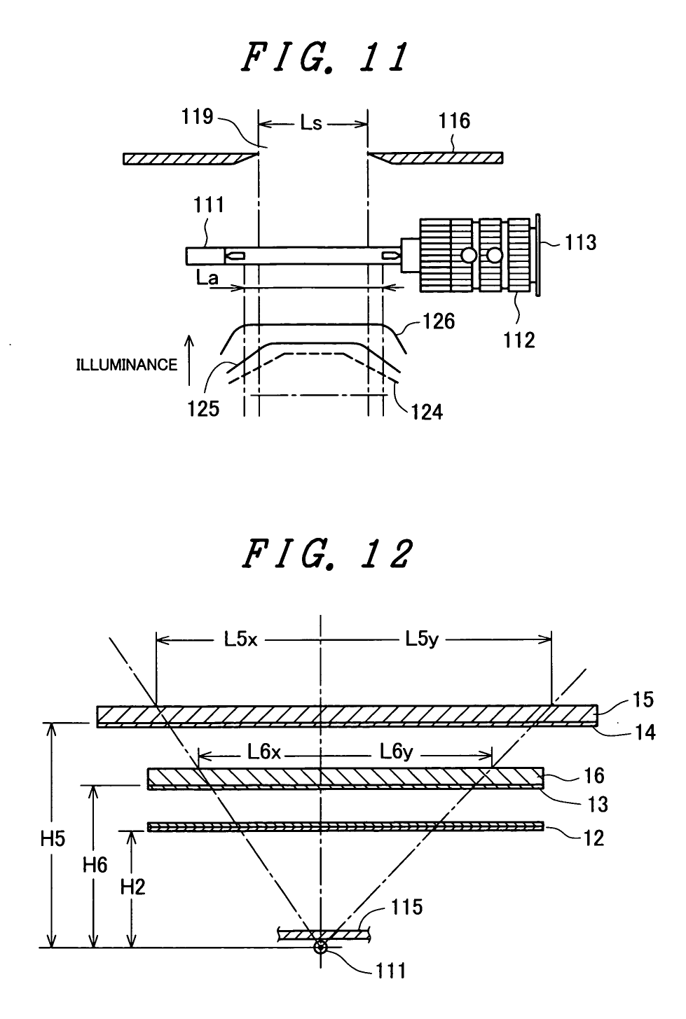

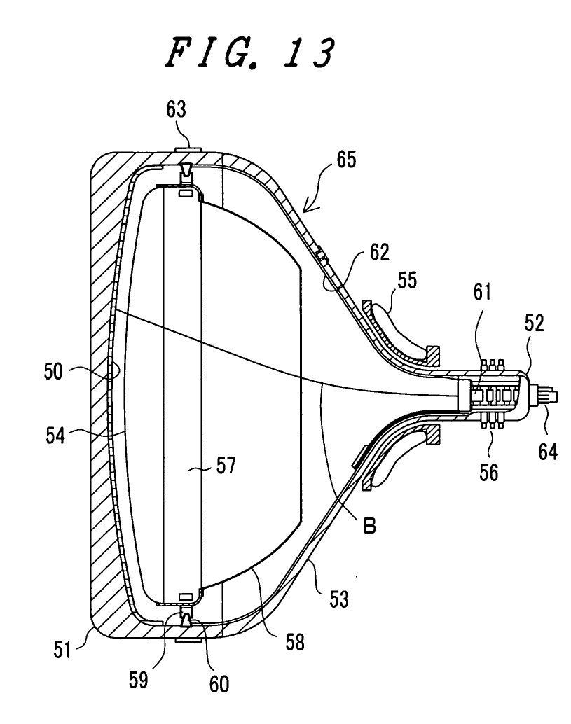

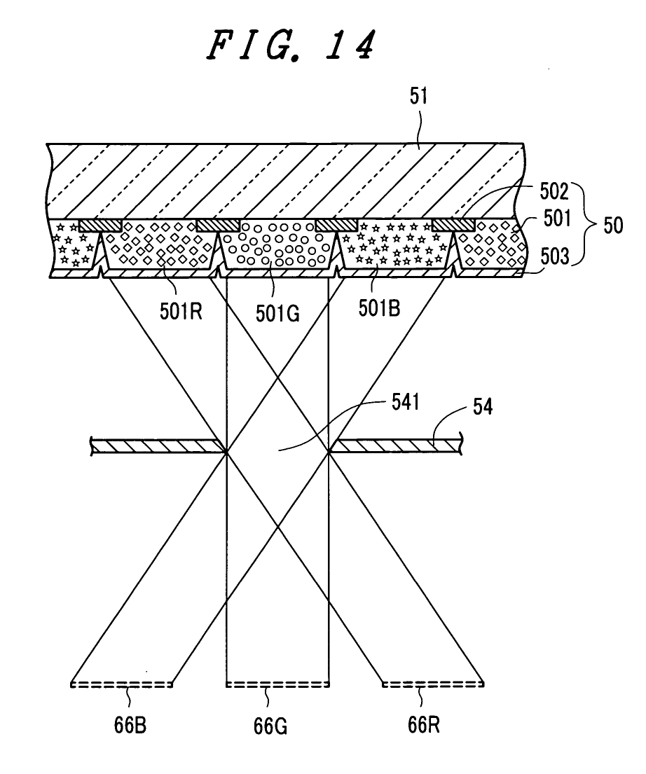

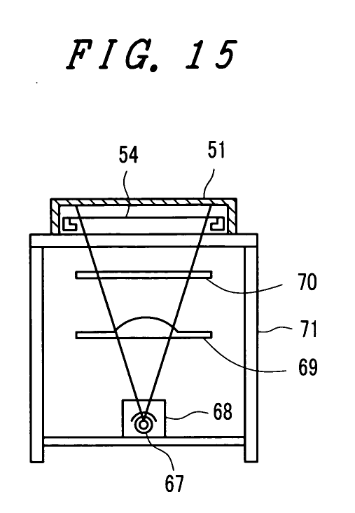

FIG. 10 and FIG. 11 are views for explaining the present invention. FIG. 10 shows the constitution of one example of a power source unit which operates the exposure light source, and FIG. 11 is a view for explaining the relationship between the light profile and an input to the exposure light source. In these respective drawings, parts identical with the parts shown in the above-mentioned drawings are given the same symbols.

First of all, in FIG. 10, numeral 120 indicates a power source unit. This power source unit 120 is a unit which operates the exposure light source 111. The power source unit 120 mounts a booster transformer 122 on a rear stage of a rectangular-wave voltage rectifying circuit 121, uses an output of the booster transformer 122 as an input of the exposure light source 111 thus controlling an output of the exposure light source 111. With the use of the booster transformer 122, the output can be increased more easily.

The output of the power source unit 120 has an output frequency thereof set to a value which falls within a range of 10 to 30 kHz, and more preferably to 20 kHz and an output to 4 kW or more provided that La=35 mm to 60 mm and Ls=(0.4 to 0.8)La, for example.

When the output frequency is less than 10 kHz, the stability of the arc discharge may be damaged, while when the output frequency exceeds 30 kHz, the light output may be fluctuated.

Further, by setting the output frequency to a value which falls within a range from 10 kHz to 30 kHz, and more preferably to 20 kHz, a core of a booster transformer 122 may be formed of a ferrite core thus reducing the weight of the transformer.

Next, in FIG. 11, numerals 124 to 126 indicate optical profiles of the respective exposure light sources 111, wherein the optical profile 124 shows a case in which an input to the exposure light source 111 is 1 kW, the optical profile 125 shows a case in which an input to the exposure light source 111 is 2 kW, and the optical profile 126 shows a case in which an input to the exposure light source 111 is 4 kW.

Optical profiles 124 to 126 shown in FIG. 11 show the above-mentioned relationship between the illuminance for every input and the optical profile under a condition that the arc length La of the exposure light source 111 and the slit length Ls are set as La=35 mm to 60 mm and Ls=(0.4 to 0.8) La.

As can be clearly understood from FIG. 11, although it is needless to say that the illuminance is increased along with the increase of the input, the optical profile per se is also changed simultaneously.

This implies that, at low inputs equal to or below 2 kw which are indicated by the optical profiles 124, 125, the exposure for a long period and the movement of the exposure light source 111 in the same plane become inevitably necessary to obtain the same exposure quantity and the same exposure area as compared with the case of 4 kw input.

On the other hand, at the input of 4 kW indicated by the optical profile 126, a desired exposure quantity and an exposure area can be obtained for a short period and, further, the operational efficiency can be remarkably enhanced with the addition of the movement of the exposure light source 111.

### Embodiment

FIG. 12 is a schematic cross-sectional view showing another example of an exposure device for explaining the method for manufacturing the color cathode ray tube of the present invention, wherein parts identical with the parts shown in the above-mentioned drawings are given the same symbols.

In FIG. 12, in performing the exposure of a flat-face-type panel which has an approximately flat outer surface and has a larger wall thickness at a peripheral portion thereof compared to a wall thickness of a center portion thereof, a distance between the exposure light source 111 and the monochroic correction lens 16 at the time of performing the exposure is set to a distance H6. On the other hand, the common correction lens 15 is arranged closer to the panel portion 18 side than the above-mentioned monochroic correction lens 16 and the distance between the light source 11 and the common correction lens 15 is set to a distance H5 which is larger than the distance H6.

Here, the exposure light source device 11 of this embodiment is configured to have the same specification as the above-mentioned embodiment 1.

Further, the respective correction lenses 15, 16 exhibit an approximately rectangular effective surface, wherein the common correction lens 15 is a lens having a curved surface which has a length L5Y in the Y-axis direction and a length L5X in the X-axis direction. Further, the monochroic correction lens 16 which has an oval lens compared to the common correction lens 15 is a lens having a curved surface which has a length L6Y in the Y-axis direction and a length L6X in the X-axis direction.

With respect to the curved surface shapes of the surfaces of the respective correction lenses, curved surface formulae are set in view of a phosphor screen size, a phosphor pixel pitch and the like. To describe a specific example of profile sizes, the order of arrangement, the sizes of arrangement and the like, in case of a 68 cm color cathode ray tube, first of all, the correction lenses are arranged in order of the monochroic correction lens 16 and the common correction lens 15 from the exposure light source 111 side, wherein the respective sizes are set as H5: 100 mm, H6: 75 mm, L5Y: 110 mm, L5X: 75 mm, L6Y: 80 mm, L6X: 55 mm. In such arrangement and sizes, a size H2 between the grading filter 12 and the exposure light source 111 is set approximately equal to a corresponding size in the conventional method.

The step for forming the black matrix film according to the present invention includes the exposure step of first phosphor pixel holes, the exposure step of second phosphor pixel holes, and the exposure step of third phosphor pixel holes.

In the exposure step of the first phosphor pixel holes according to this embodiment, the exposure is performed by arranging the common correction lens 15 and the first monochroic correction lens 16C having an outer diameter smaller than an outer diameter of the common correction lens 15 between the inner surface of the panel and the exposure light source 111.

In the exposure step of the second phosphor pixel holes, the exposure is performed by arranging the common correction lens 15 and the second monochroic correction lens 16S1 having an outer diameter smaller than the outer diameter of the common correction lens 15 between the inner surface of the panel and the exposure light source 111.

In the exposure step of the third phosphor pixel holes, the exposure is performed by arranging the common correction lens 15 and the third monochroic correction lens 16S2 having an outer diameter smaller than the outer diameter of the common correction lens 15 between the inner surface of the panel and the exposure light source 111.

The common correction lens 15 is used in common in the exposure step of the first phosphor pixel holes, in the exposure step of the second phosphor pixel holes and in the exposure step of the third phosphor pixel holes.

The common correction lens performs the common correction in the exposures performed three times. Further, the respective monochroic correction lenses perform the individual corrections for respective colors. Since the correction component in common and the correction components for respective colors are separated from each other, it is possible to form the correction lenses with high accuracy and the proper beam landing can be easily achieved.

The present invention is not limited to the above-mentioned embodiments and various modifications can be made without departing from the technical concept of the present invention described in claims.

What is claimed is:

1. A manufacturing method of a color cathode ray tube comprising a panel portion which includes a phosphor screen which forms a black matrix film having a plurality of opening portions and phosphor layer which are arranged in the opening portions of the black matrix film thereon and a shadow mask which is arranged to face the phosphor screen of the panel portion in an opposed manner and includes a large number of electron beam apertures, wherein
an exposure light source used in an exposure step for forming the black matrix film is formed of an ultra high pressure mercury lamp having an arc length of 35 to 60 mm.

2. A manufacturing method of a color cathode ray tube according to claim 1, wherein the exposure light source is formed of an ultra high pressure mercury lamp having an arc length of 50 mm.

3. A manufacturing method of a color cathode ray tube according to claim 1, wherein the exposure is performed by relatively displacing a space of the exposure light source and a surface of the panel to be exposed.

4. A manufacturing method of a color cathode ray tube according to claim 1, wherein an input frequency to the exposure light source is set to a range from 10 to 30 kHz.

5. A manufacturing method of a color cathode ray tube according to claim 3, wherein an input frequency to the exposure light source is set to 20 kHz.

6. A manufacturing method of a color cathode ray tube comprising a panel portion which includes a phosphor screen which forms a black matrix film having a plurality of opening portions and phosphor layer which are arranged in the opening portions of the black matrix film thereon and a shadow mask which is arranged to face the phosphor screen of the panel portion in an opposed manner and includes a large number of electron beam apertures, wherein
an exposure light source used in an exposure step for forming the phosphor layer is formed of an ultra high pressure mercury lamp having an arc length of 35 to 60 mm.

7. A manufacturing method of a color cathode ray tube according to claim 6, wherein the exposure light source is formed of an ultra high pressure mercury lamp having an arc length of 50 mm.

8. A manufacturing method of a color cathode ray tube according to claim 6, wherein the exposure is performed by relatively displacing a space of the exposure light source and a surface of the panel to be exposed.

9. A manufacturing method of a color cathode ray tube according to claim 5, wherein an input frequency to the exposure light source is set to a range from 10 to 30 kHz.

10. A manufacturing method of a color cathode ray tube according to claim 7, wherein an input frequency to the exposure light source is set to 20 kHz.

11. An exposure device used in the manufacture of a phosphor screen of a color cathode ray tube comprising a panel portion which includes the phosphor screen which forms a black matrix film having a plurality of opening portions and phosphor layer which are arranged in the opening portions of the black matrix film thereon and a shadow mask which is arranged to face the phosphor screen of the panel portion in an opposed manner and includes a large number of electron beam apertures, wherein
the exposure device further includes an exposure light source which exposes the panel portion through the shadow mask, an aperture plate which is arranged between the exposure light source and the shadow mask and has an approximately rectangular slit which allows a portion of exposure beams to pass therethrough, a correction lens and a correction filter which are arranged between the aperture plate and the shadow mask, and a power source unit which operates the exposure light source, and
the exposure light source is formed of an ultra high pressure mercury lamp having an arc length of 35 to 60 mm.

12. An exposure device used in the manufacture of a phosphor screen of a color cathode ray tube according to claim 11, wherein the exposure light source is formed of an ultra high pressure mercury lamp having an arc length of 50 mm.

13. An exposure device used in the manufacture of a phosphor screen of a color cathode ray tube according to claim 11, wherein a length of the slit in the direction parallel to a tube axis of the exposure light source is set smaller than the arc length of the exposure light source.

14. An exposure device used in the manufacture of a phosphor screen of a color cathode ray tube according to claim 13, wherein a length of the slit in the direction parallel to a tube axis of the exposure light source is set to a ratio which falls within a range from 0.4 to 0.8 with respect to the arc length of the exposure light source.

15. An exposure device used in the manufacture of a phosphor screen of a color cathode ray tube according to claim 11, wherein an output frequency of the power source unit is set to a value which falls within a range from 10 to 30 kHz.

16. An exposure device used in the manufacture of a phosphor screen of a color cathode ray tube according to claim 14, wherein an output frequency of the power source unit is set to 20 kHz.

17. An exposure device used in the manufacture of a phosphor screen of a color cathode ray tube according to claim 11, wherein the exposure device includes a mechanism which swing the exposure light source in the same plane.
